(19) United States
(12) Patent Application Publication
(10) Pub. No.: US 2024/0003677 A1
(43) Pub. Date: Jan. 4, 2024

(54) A DEVICE AND A METHOD TO MEASURE AND MONITOR PHYSICAL PROPERTIES OF MOVING WEB OF SLIT PLASTIC FILM TAPES

(71) Applicant: Lohia Mechatronik Private Limited, Kanpur (IN)

(72) Inventor: Siddharth Lohia, Kanpur (IN)

(73) Assignee: Lohia Mechatronik Private Limited, Kanpur, UP (IN)

(21) Appl. No.: 18/255,057

(22) PCT Filed: Nov. 30, 2021
(86) PCT No.: PCT/IB2021/061103

§ 371 Date: May 30, 2023

(30) Foreign Application Priority Data
Dec. 1, 2020 (IN) 202011029592

(51) Int. Cl. G01B 11/06; G01B 11/04

(52) U.S. Cl. CPC G01B 11/0691; G01B 11/046

(57) ABSTRACT

A device to monitor and analyze physical properties of moving web of slit plastic film tapes moving over a rotating roller. The device has an optical sensor and camera box having an optical source which emits a beam of homogeneous light transmitter, and a receiver having a line scan camera to receive light sent by transmitter. The device also has an initial measurement unit, a PLC controller, a central processing unit (CPU) and a display monitor. The device moves end to end over the rotating roller to capture images of tapes and data on light beam and sends them to PLC and CPU and then to the display monitor. The images sent by camera and the light beam data sent by the receiver are analysed to determine the physical properties such as edge fibrillation and colour, thickness, width, and the uniformity of spacing of the tapes.

### FIELD OF INVENTION

The invention is related to a sensor box and camera system to monitor and analyze edge fibrillation, thickness, width, and color of moving web of slit plastic film tapes being used in different applications. Such monitoring and analyzing the web significantly increases the quality of the tapes made from it and makes the process easier by reducing the wastage and optimizing the quality of the tapes.

### BACKGROUND OF THE INVENTION

Plastic slit tapes are manufactured by slitting an endless plastic film/sheet made by extrusion process. In the extrusion process a machine is designed to produce continuous endless flat plastic film/sheet made of different material compositions such as PET, ABS, PVC, PP, LDPE, HDPE, blends of polyolefin or blends of other plastic materials after being melt and coming out through a flat extrusion die and further after cooling of this melt.

After cooling the flat film/sheet passes through a set of blades positioned at a distance to each other depending on the width of the slit tapes required. Thus, the film/sheet slitted into multiple tapes through these set of blades.

The monitoring of width and thickness of these slit tapes are important in such a way to produce a quality tapes for further applications. It is also an important point to observe the edges of these tapes after being slit through the blades to know when the cutting edges of the blades need changing or when to replace the blades to avoid edge fibrillation of the tapes. Edge fibrillation is a phenomenon that occurs when blades lose their sharpness and become blunt. Fibrillated edges often present a weak point from where running tapes can get tom under tension, which consequently creates a lot of wastage. Edge fibrillation can also result in undesirable variation in thickness and width of the tapes and lowers the quality of the products made from such tapes.

Another important point to be observed is the color consistency of the tape in case of a colored tape. Variation in color of the tapes lowers the quality of the products made from such tapes.

There is therefore a need for a system which eliminates above stated problems while manufacturing web of plastic slit tapes.

Some of the conventional scanners are disclosed in the patent U.S. Pat. No. 7,199,884B2, EP1975553A1, US20130083332A1, these systems were provided to measure and analyze the thickness of a moving web before the slitting process. These are used to measure the thickness and width of the moving web of flat film/sheet. The thickness, width, edge fibrillation and color scanning and analyzing methods were not disclosed in these patents. The problem to know the time of changing of the blades were still a problem with the process of making the web of slit film tapes.

It is therefore evident that there is currently no technical solution in the market for measuring, monitoring, inspecting, and analyzing the thickness, width, edge fibrillation and color of the moving web of slit film tapes.

### OBJECTS OF THE INVENTION

Accordingly, it is an object of the present invention to provide a system which can measure, monitor, and analyses the width & thickness of the continuous moving web of plastic film slit tapes.

Another object of the present invention is to provide a system which can monitor and analyses the edge fibrillation of the tapes to reduce wastages due to breakage of moving tapes and to maintain the quality of the tapes by changing the blades cutting edges and to change the blades after optimum using time of a blade's life.

Another object of the present invention is to provide a system which can inspect and give the real time images of the colored tapes to analyse the variation in color of the tapes.

### BRIEF DESCRIPTION OF FIGURES

The objects and advantages thereof may be understood by referring to the following description, taken with the accompanying drawings and actual images:

FIG. 1 shows an actual microscopic image of slit tape with fibrillation at the edges.

FIG. 2 shows an actual microscopic image of cutting blade edges, one having sharp edges (before being used) and another having blunt edge (after being used).

FIG. 3 shows a schematic of a sensor and camera box system fixed with a frame to monitor and analyses the thickness, width, edge fibrillation of running web of tapes and to provide real time images of tapes for color variation monitoring

FIG. 3A shows an isometric view of the system shown in FIG. 3.

FIG. 4 shows a schematic of a sensor and camera box system (2) fixed with a frame (4) along with a schematic of running tapes (s) passing through the rotating roller (3) provided in the system.

FIG. 4A shows an isometric view of the system shown in FIG. 4.

FIG. 4B shows a path of running web of tapes (S1, S2 . . . Sn) over the rotating roller (3) and angle which is being created on the rotating roller (3) by the tapes

FIG. 5 shows a schematic of sensor and camera box system

FIG. 5A shows a schematic of side view of sensor and camera box system.

FIG. 5B shows a schematic of bottom view of sensor and camera box system

FIG. 6 shows the block diagram of signal transfer used in the invention

FIG. 7 shows a graph having thickness and movement of the sensor box with time

FIG. 8 shows a representative diagram of the light transmitted and received through the rotating roller having slit tapes passing through the roller

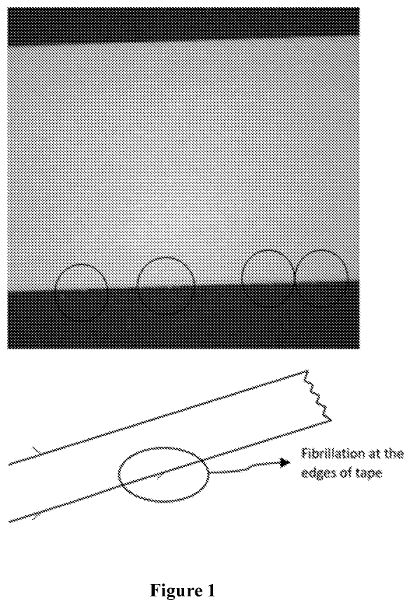

### SUMMARY OF INVENTION

The invention is related to a device incorporating a sensor and camera box to monitor and analyze physical properties of moving web of plastic slit film. Physical properties being monitored and analysed include edge fibrillation and colour, thickness, width, and the uniformity of spacing of the tapes. Such monitoring and analyzing the web significantly increases the quality of the tapes made from it and makes the process easier by reducing the wastage and optimizing the quality of the tapes. The device is fixed in an integrated frame (4) and capable of moving over a rotating roller (3) over which aid moving web of slit plastic film passes. The device has an optical sensor and camera box (2) having a transmitter (2A) and a receiver (2B). The transmitter (2A) has an optical source which emits a beam of homogeneous light, and the receiver (2B) has a line scan camera which receives the light coming from said transmitter (2A). The device also has an IMU (initial measurement unit) (5), a PLC controller (6), a CPU (central processing unit) (7) and a display monitor (8). The device moves end to end over said roller whereby said sensor box (2) captures the high-resolution images of the tapes through a high-speed high resolution camera (2C) and data on the light beam received by the receiver (2B) and sends them to the PLC controller (6) and central processing unit (7) from where these images sent to the display monitor (8). The images captured by camera (2C) and the light beam data sent by the receiver (2B) is analysed to determine the physical properties such as edge fibrillation and colour, thickness, width, and the uniformity of spacing of the tapes.

### List of Parts

S—Continuous web of multiple slit plastic film Tapes (S1, S2, . . . , Sn) having thickness (T1, T2, . . . , Tn) and width (WI, W2, . . . , Wn) whereas the gap between the tapes is (GI, G2, . . . , Gn)
1—Single slit plastic film (Tape) having width-Wand Thickness-T
2—Sensor and camera box system
2A—Sensor Transmitter
2B—Sensor Receiver
2C—High-Speed High-Resolution Camera
3—Rotating Roller
4—Integrated measuring frame
5—IMU (Initial Measurement Unit)
6—PLC Controller
7—Central Processing Unit (CPU)
8—Display

### DETAILED DESCRIPTION OF THE INVENTION

The present invention is an efficient sensor and camera box system for monitoring, analyzing the thickness, width, edge fibrillation and color of the moving web of slit tapes to control the quality of the tape which further improves quality of the end products made from these tapes and to reduce the wastage.

Fig. I shows the microscopic view of edge fibrillation of the tape. In the current problem operator changes the blades edge or replace the blades according to his experience which is not a suitable way to do it. Early changes of blades costs to the product as we would not be utilizing the maximum life of the blades while late changing of the blades leads to breakage of the continuous running tapes creating a lot of wastages. One of the advantages of the current system is to know the exact time to change the blades by monitoring the edge fibrillation of the tapes which optimizes the utilization of the blades life.

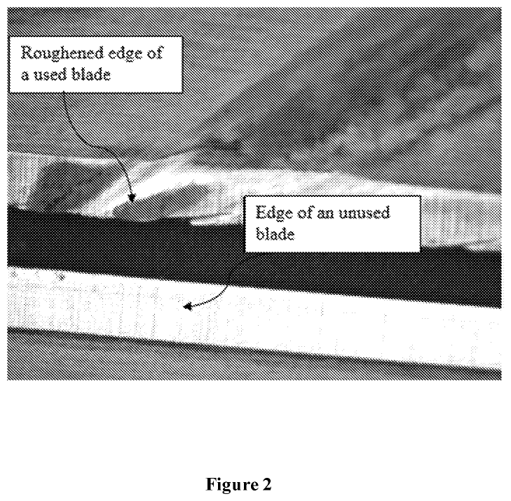

FIG. 2 shows actual microscopic images of the blade's edges, it is clear from the images that after a long-time of running blades lost its sharpness, so the blunt blades start fibrillating the tape edges. This invention monitors the fibrillation in the tapes by capturing and showing the real time images of the tapes and accordingly the operator changes the blades edges or replaces the blades.

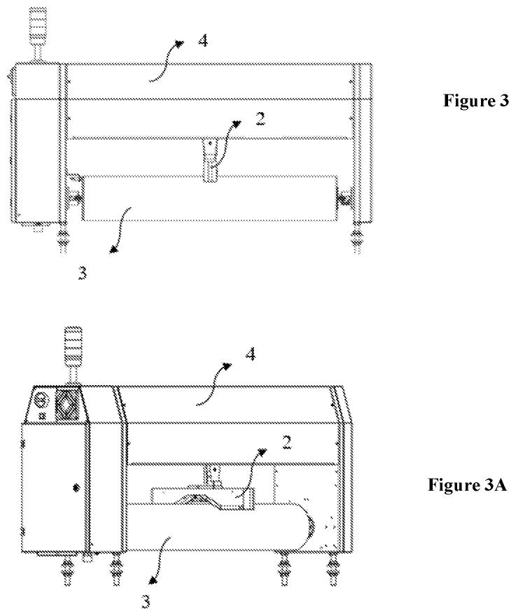

FIGS. 3 and 3A shows a schematic of a sensor and camera box system (2) fixed in an integrated frame (4) capable of moving over a rotating roller (3). This sensor and camera box system moves end to end over the roller where the speed of movement of the sensor box is adjustable.

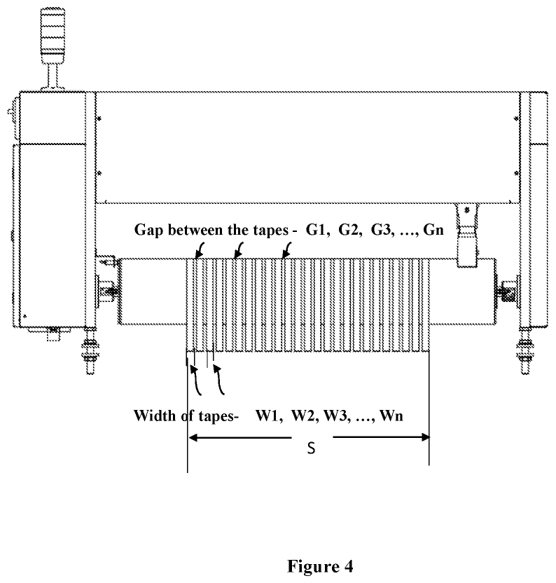

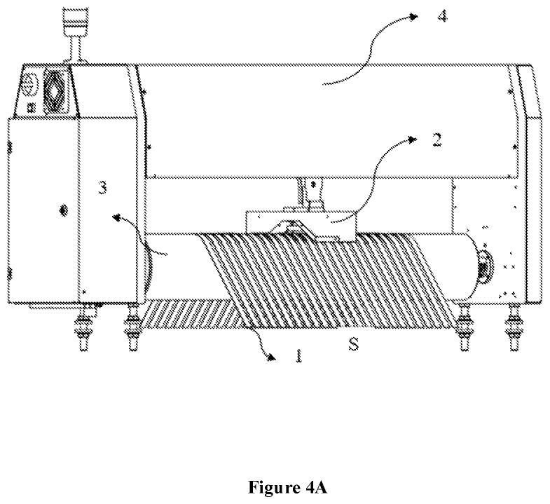

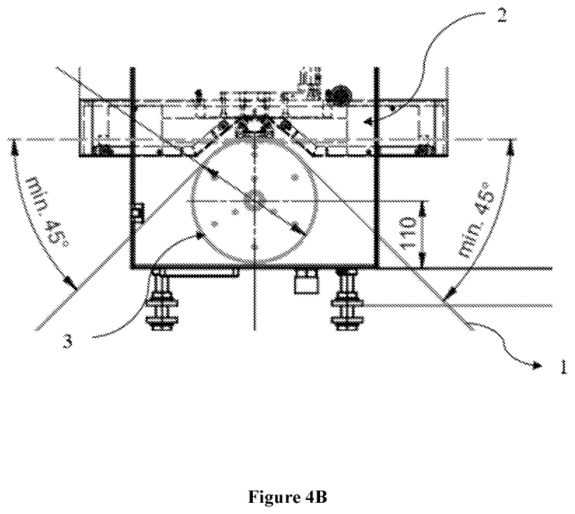

FIGS. 4 and 4A shows a schematic of sensor and camera box system integrated in a measuring frame (4), continuous web of multiple slit plastic tapes (S) is running over the rotating roller (3) FIG. 4B shows an angle of the tape path from the top surface plane of the rotating roller.

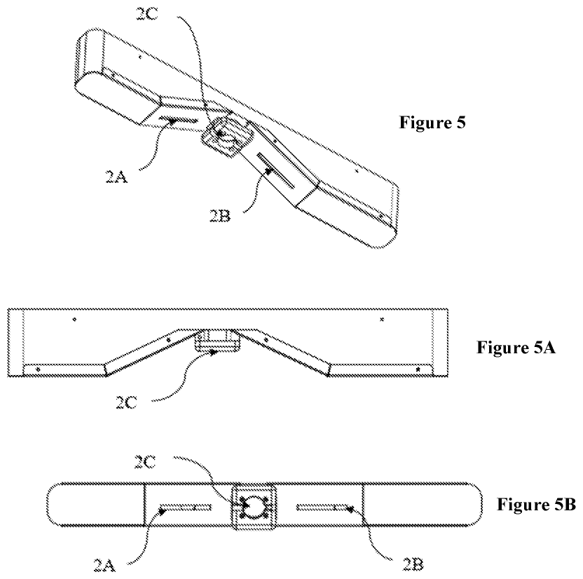

FIG. 5 shows a schematic of sensor and camera box system (2) having angled position of sensor transmitter (2A), sensor receiver (2B) and position for mounting a camera (2C). Fig. SA and SB show the sensor and camera box system from different angles of views.

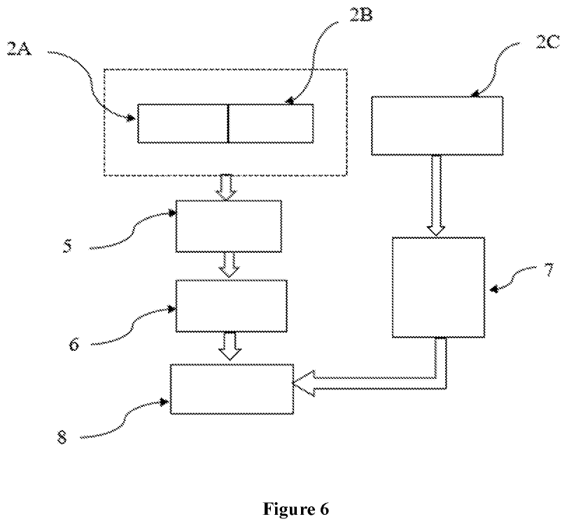

FIG. 6 shows the block diagram of signal transfer used in the invention having a sensor and camera system comprising a transmitter, receiver, and camera (2A, 2B and 2C), an IMU (initial measurement unit) (5), a PLC controller (6), a CPU (central processing unit) (7) and a display monitor (8).

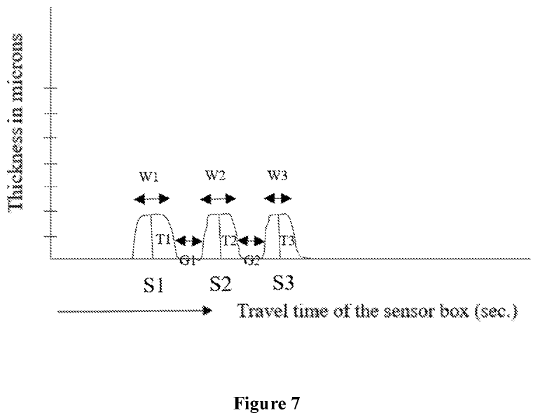

FIG. 7 shows a graph illustrating the graph between thickness and time, S1, S2 and S3 are the tapes being measured, T1, T2 and T2 are the corresponding thicknesses of the individual tapes. WI, W2 and W3 are the corresponding widths of the individual tapes S1, S2 and S3 while GI and G2 are the gaps between the tapes SI and S2.

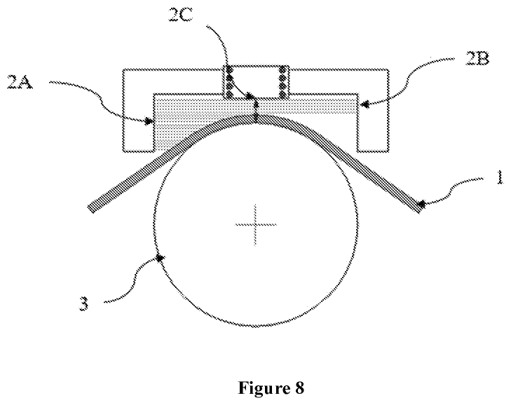

FIG. 8 shows a representative figure representing how a band of light beam being transmitted from the transmitter (2A) and being received by the receiver (2B) after passing through the rotating roller (3). This also shows a camera (2C) mounted in the sensor box (2)

As an object of the invention is the measurement of the thickness (T1, T2, . . . , Tn) and width (WI, W2, . . . , Wn) of the individual tapes SI, S2, S3 Sn is required. These tapes pass over the rotating roller (3) in such a way as to create a minimum 45° angle from the plane of top surface of the rotating roller (3) as shown in an embodiment given in FIG. 4(B).

An optical sensor system is used having a transmitter (2A) and a receiver (2B). An optical source is used as the transmitter which emits homogeneous light while a line scan camera is used as a receiver which receives the light coming from transmitter.

Transmitter and receiver are placed tangentially to the roller facing each other in longitudinal direction in such a way that the receiver can receive the band of light coming from the transmitter as illustrated in FIG. 8.

When there is no object between the transmitter and receiver, the band of light or the height of the light would be continuously received by the receiver passing above the roller surface.

As shown in FIG. 4A when a web of multiple plastic slit film tapes (S1, S2, S3, . . . , Sn) running over the measuring roller having widths (WI, W2, W3, . . . , Wn) and thickness (T1, T2, T3, . . . , Tn) the height of light received from the receiver is less than the height of light it was being received when there was no web of tape running over the roller as illustrated in FIGS. 3 and 3A although the height of light will be received in full when the sensor passes through the gaps between the tapes (G1, G2, G3, . . . , Gn). This reduction in received light to the receiver is due to presence of tapes between the transmitter and receiver and over the roller.

As the tapes are coming in the path of light transmitted due to shadow created by these tapes up to the thickness of the tapes, the reduction in the height of light is proportional to the thickness (T) of the tape.

As explained, the sensor box is moving end to end over the rotating roller so the receiver will be receiving the light throughout the width of the roller as we can see there is a gap (GI, G2, G3, . . . , Gn) between the tapes (SI, S2, S3, . . . , Sn) when the transmitter and receiver passes through these gaps the receiver receives the full height of light over the roller top surface as in the gap there is no object.

As shown in the graph provided in FIG. 7, there tapes (SI, S2, S3) are shown having thickness (T1, T2 and T3) and width (WI, W2 and W3) the gap between the individual tapes S1, S2 and S3 are GI and G2. When the sensor box passes through the first tape (SI) light transmitted from the transmitter reduced which corresponding to the thickness of the tape (T1). When sensor box moving further over the tape (SI) after passing through the complete width of tape (WI) it starts passing through the GI. As the sensor reaches in the gap (GI) it again starts receiving the complete band of light. Thus, we can get the width of an individual tape (WI).

This process continues till the last tape (Sn), and we will get the corresponding thicknesses (T1, T2, . . . , Tn) and Widths (WI, W2, . . . , Wn).

Another object of the invention is to get the real time images of the running web of the tapes (S1, S2, . . . , Sn) to get the operator aware of the fibrillation at the edges of the tapes to come to a judgement to change the blade edges or replace the blades to avoid breakage of the tapes which if not done in time leads to a wastage and color of the tapes to see the color of the tapes to see for any variation in the color. If the operator sees a variation the color of the individual tapes, he can separate that tape and can take a corrective action to get a better dispersion of the color into the tapes to avoid any color variation into the final product.

In a running web of tapes, it is impossible to see the edges of the tapes to see the fibrillation and color to overcome this problem a camera mainly a high-resolution high-speed line scan camera (2C) is provided in the sensor box.

As the sensor box moves over the roller and web of the tapes (S) this camera captures high resolution images. These images can be seen by operator to analyze the tapes (S1, S2, S3, . . . , Sn) for any fibrillation at the edges of the tapes due to reduced sharpness of the blades being used for slitting of these tapes.

Also, the operator can see the Realtime images of the tapes to see the visual color variation into the tapes (SI, S2, S3, . . . , Sn).

Sensor system comprising of a transmitter sensor (2A) and a receiver (2B) connected to an Initial Measuring Unit (5) as shown in block diagram provided in FIG. 6. The signal from the sensor system comprising optical sensor (2A and 2B) send to this Initial Measuring Unit, IMU (5) where primary filtering of the signal is done.

This initial measuring unit, IMU (5) sends the differential voltage signal to the PLC controller (6) through different communication protocols; TCP-IP (Transmission Control Protocol-Internet Protocol) or modbus or RS485 or any other industrial communication protocols.

The differential voltage data sent to the PLC controller (6) converts to the thickness (T1, T2, . . . , Tn) and widths (WI, W2, . . . , Wn) by applying the software algorithm to the PLC.

From the PLC controller (6), This thickness and width values sent to the monitor display (8) where the thickness and width data can be seen and can be used for further analyzing the data e.g., to record the production values, to generate the production report to map the extrusion die to the corresponding tapes (SI, S2, . . . , Sn) so that the control of the thickness and width can be done easily through manually or automatically.

A high-speed high-resolution line scan camera (2C) mounted in the sensor box (2) captures the high-resolution images of the tapes while sensor box run over the tapes (SI, S2, . . . , Sn) these images sent to the central processing unit (7) from where these images sent to the display monitor (8). These images can be referred by the operator in real time to see the fibrillation at the edges of the tapes and visual color variation in the tapes.

The invention also discloses a method to monitor physical properties of moving web of slit plastic film. The physical properties include size of the tapes, in particular the width and thickness, and uniformity of their positioning, represented by the gaps between any two consecutively positioned tapes, fibrillation at the edges of tapes, and colour of the tapes. The method discloses how to measure certain parameters using the sensor box camera (2) disclosed in the invention and assess the aforementioned properties.

The measurement of width (WI, W2, . . . , Wn) and thickness (TI, T2, . . . , Tn) of running web of tapes (S1, S2, . . . , Sn) having gaps (GI, G2, . . . , Gn) between the tapes over the rotating roller (3)) is carried out as follows.
Web(s) of running tapes (SI, S2, . . . , Sn) pass through the rotating roller (3) by creating an angle (minimum 45° C.) from the top surface of the rotating roller as illustrated in the FIG. 4B.
Sensor box system (2) comprises a set of optical sensors, a transmitter (2A), a receiver (2B) move in cross direction over the roller covering the whole width of the web(s)
Transmitter emits light band having a height, as illustrated in FIG. 8, this band of light passes over the rotating roller and received by the receiver. When the web(s) of the tapes absent over the rotating roller (3) full height of light will be received by the receiver. When a web of running tapes (s) inserted in the path over the roller (3) a part of the height of light will be abstracted by this insertion of the web(s) in the path of the light. This reduction in height of light received by the receiver is directly proportional to the thicknesses of the tapes (T1, T2, . . . , Tn) There is the gap between the tapes (GI, G2, . . . , Gn) so the reduction in the height of light received will be limited to the width (WI, W2, . . . , Wn) of the tapes only because when the sensor passes through the gaps (GI, G2, . . . , Gn) full height of light would be received by the receiver.
Thus, the width (WI, W2, . . . , Wn) can be drawn from the corresponding distance of travel of the sensor box as illustrated in FIG. 7.
voltage signal from the sensor system comprising optical sensor (2A and 2B) send to the Initial Measuring Unit, IMU (5) where primary filtering of the signal is done.
This differential voltage data is sent to the PLC controller (6) through different communication protocols; TCP-IP (Transmission Control Protocol-Internet Protocol) or modbus or RS485 or any other industrial communication protocols. The differential voltage data sent to the PLC controller (6) converts to the thickness (T1, T2, . . . , Tn) and widths (WI, W2, . . . , Wn) by applying the software algorithm to the PLC.
From the PLC controller (6), This thickness and width values sent to the monitor display (8) where the thickness and width data can be seen and can be used for further analyzing the data e.g., to record the production values, to generate the production report to map the extrusion die to the corresponding tapes (SI, S2, . . . , Sn).

Assessment of fibrillation of the tapes at their edges is carried out by capturing the images of the tapes and analysing them for edge fibrillation and color of the individual tapes
A high-speed high-resolution line scan camera (2C) is fixed in the sensor box vertically above the rotating roller (3) in such a way to capture the images of the running web(s) of the tapes (SI, S2, . . . , Sn).
Images captured by this camera (2C) sent to the central processing unit (7) from where these images sent to the display monitor (8).
These images can be referred by the operator in real time to see the fibrillation at the edges of the tapes and visual color variation in the tapes.
Also, in case of web(s) of tapes (SI, S2, . . . , Sn) running at high speed, the operator can refer the images being stored and can see for the edge fibrillation at the edges and for any variation in the color.

The characterising features of the method of the invention to monitor physical properties of moving web of slit plastic film are:
passing the web(s) of running tapes (SI, S2, . . . , Sn) over the rotating roller (3) by maintaining the tapes at an angle (minimum 45 C) with the direction of travel
emitting light beam of a predetermined height from the transmitter (2A) of the sensor box (2) over the rotating roller (3) and receiving it by the receiver (2B), and also capturing the images of the running web(s) of the tapes with the high-resolution line scan camera (2C)
collecting the information on the height of the light beam received by said receiver (2B) at a number of points along the whole width of said web and passing it in the form of voltage signals to the initial measuring unit (5) converting the signals corresponding to various points along the width of the web into thickness and width of individual tapes of the web, and also the gaps between any two consecutively positioned tapes
determining the variation in thickness and width of the individual tapes and assessing whether they are within the acceptable range
displaying the values of thickness and widths of tapes and gaps between any two consecutively placed tapes on a display monitor (8)
sending the images captured by said camera (2C) to the central processing unit (7) from where sending the images to the display monitor (8). determining the level of fibrillation at the edges of the tapes and visual color variation in the tapes.

In an embodiment of the method, the sensor box (2) used in the method moves end to end over said rotating roller (3) and said receiver (2A) receives the light emitted by said transmitter (2A) throughout the width of said roller.

In another embodiment of the method, the transmitter (2A) and receiver (2B) are placed tangentially to said roller and facing each other in longitudinal direction for said receiver (2B) to receive the band of light coming from said transmitter (2A).

In a further embodiment of the method, the transmitter (2A) emits homogeneous light and said receiver (2B) is a first line scan camera.

While the above description contains much specificity, these should not be construed as limitation in the scope of the invention, but rather as an exemplification of the preferred embodiments thereof. It must be realized that modifications and variations are possible based on the disclosure given above without departing from the spirit and scope of the invention. Accordingly, the scope of the invention should be determined not by the embodiments illustrated, but by the appended claims and their legal equivalents.

1. A device to monitor physical properties of moving web of slit plastic film, said device being fixed in an integrated frame and capable of moving over a rotating measuring roller over which aid moving web of slit plastic film passes, characterized in that said device comprises:
an optical sensor and camera box having a transmitter and a receiver, wherein said transmitter has an optical source which emits homogeneous light, and said receiver has a line scan camera which receives the light coming from said transmitter; and
an initial measurement unit (IMU), a PLC controller, a central processing unit (CPU) and a display monitor, wherein said device moves end to end over said roller whereby said sensor box comprising a line scan camera captures the high-resolution images of the tapes and sends them to said central processing unit from where these images sent to the display monitor.

2. The device as claimed in claim 1 wherein said sensor box moves end to end over said rotating roller and said receiver receives the light emitted by said transmitter throughout the width of said roller.

3. The device as claimed in claim 1, said transmitter and receiver are placed tangentially to said roller and facing each other in longitudinal direction for said receiver to receive the band of light coming from said transmitter.

4. The device as claimed in claim 1, wherein said transmitter emits homogeneous light and said receiver is a first line scan camera.

5. The device as claimed in claim 1, wherein said sensor box has a high-speed high-resolution second line scan camera to capture high-resolution images of moving tapes while said sensor box runs over said the tapes, said images being sent to said central processing unit following which they are sent to said display monitor.

6. The device as claimed in claim 1, wherein the communication protocol used by said initial measuring unit, IMU to send the differential voltage data to said PLC controller is Transmission Control Protocol-Internet Protocol (TCP-IP) or modbus or RS485.

7. A method to monitor physical properties of moving web of slit plastic film tapes using the device as claimed in claim 1, characterised in that said method has the steps of:
a. passing the web of slit plastic film tapes over the rotating roller by maintaining the tapes at an angle of at least 45° with the direction of travel;
b. emitting light beam of a predetermined height from the transmitter of the sensor box over the rotating roller and receiving it by the receiver, and also capturing the images of the running web of the tapes with the high-resolution line scan camera;
c. collecting the information on the height of the light beam received by said receiver at a number of points along the whole width of said web and passing it in the form of analog signals to the initial measuring unit;
d. converting the signals corresponding to various points along the width of the web into thickness and width of individual tapes of the web, and also the gaps between any two consecutively positioned tapes;
e. determining the variation in thickness and width of the individual tapes and assessing whether they are within the acceptable range;
f. displaying the values of thickness and widths of tapes and gaps between any two consecutively placed tapes on a display monitor;
g. sending the images captured by said camera to the central processing unit from where sending the images to the display monitor; and
h. determining the level of fibrillation at the edges of the tapes and visual color variation in the tapes.

8. The method as claimed in claim 7, wherein said the sensor box (2) used in the method moves end to end over said rotating roller and said receiver (2A) receives the light emitted by said transmitter (2A) throughout the width of said roller.

9. The method as claimed in claim 7 wherein said transmitter and receiver are placed tangentially to said roller and facing each other in longitudinal direction for said receiver to receive the band of light coming from said transmitter.

10. The method as claimed in claim 7, wherein said transmitter emits homogeneous light and said receiver is a first line scan camera.

11. The device as claimed in claim 2, said transmitter and receiver are placed tangentially to said roller and facing each other in longitudinal direction for said receiver to receive the band of light coming from said transmitter.

12. The device as claimed in claim 11, wherein said transmitter emits homogeneous light and said receiver is a first line scan camera.

13. The device as claimed in claim 12, wherein said sensor box has a high-speed high-resolution second line scan camera to capture high-resolution images of moving tapes while said sensor box runs over said the tapes, said images being sent to said central processing unit following which they are sent to said display monitor.

14. A method to monitor physical properties of moving web of slit plastic film tapes using the device as claimed in claim 13, characterised in that said method has the steps of:
a. passing the web of slit plastic film tapes over the rotating roller by maintaining the tapes at an angle with the direction of travel;
b. emitting light beam of a predetermined height from the transmitter of the sensor box over the rotating roller and receiving it by the receiver, and also capturing the images of the running web of the tapes with the high-resolution line scan camera;
c. collecting the information on the height of the light beam received by said receiver at a number of points along the whole width of said web and passing it in the form of analog signals to the initial measuring unit;
d. converting the signals corresponding to various points along the width of the web into thickness and width of individual tapes of the web, and also the gaps between any two consecutively positioned tapes;
e. determining the variation in thickness and width of the individual tapes and assessing whether they are within the acceptable range;
f. displaying the values of thickness and widths of tapes and gaps between any two consecutively placed tapes on a display monitor;
g. sending the images captured by said camera to the central processing unit from where sending the images to the display monitor; and
h. determining the level of fibrillation at the edges of the tapes and visual color variation in the tapes.

15. A method to monitor physical properties of moving web of slit plastic film tapes using the device as claimed in claim 5, characterised in that said method has the steps of:
a. passing the web of slit plastic film tapes over the rotating roller by maintaining the tapes at an angle with the direction of travel;
b. emitting light beam of a predetermined height from the transmitter of the sensor box over the rotating roller and receiving it by the receiver, and also capturing the images of the running web of the tapes with the high-resolution line scan camera;
c. collecting the information on the height of the light beam received by said receiver at a number of points along the whole width of said web and passing it in the form of analog signals to the initial measuring unit;
d. converting the signals corresponding to various points along the width of the web into thickness and width of individual tapes of the web, and also the gaps between any two consecutively positioned tapes;
e. determining the variation in thickness and width of the individual tapes and assessing whether they are within the acceptable range;
f. displaying the values of thickness and widths of tapes and gaps between any two consecutively placed tapes on a display monitor;
g. sending the images captured by said camera to the central processing unit from where sending the images to the display monitor; and
h. determining the level of fibrillation at the edges of the tapes and visual color variation in the tapes.

16. The device as claimed in claim 2, wherein said transmitter emits homogeneous light and said receiver is a first line scan camera.

17. The device as claimed in claim 3, wherein said transmitter emits homogeneous light and said receiver is a first line scan camera.

18. The device as claimed in claim 2, wherein said sensor box has a high-speed high-resolution second line scan camera to capture high-resolution images of moving tapes while said sensor box runs over said the tapes, said images being sent to said central processing unit following which they are sent to said display monitor.

19. The device as claimed in claim 3, wherein said sensor box has a high-speed high-resolution second line scan camera to capture high-resolution images of moving tapes while said sensor box runs over said the tapes, said images being sent to said central processing unit following which they are sent to said display monitor.

20. The device as claimed in claim 4, wherein said sensor box has a high-speed high-resolution second line scan camera to capture high-resolution images of moving tapes while said sensor box runs over said the tapes, said images being sent to said central processing unit following which they are sent to said display monitor.
